(19) United States
(12) Patent Application Publication
(10) Pub. No.: US 2016/0101842 A1
(43) Pub. Date: Apr. 14, 2016

(54) FUEL TRANSFER AND STORAGE SYSTEMS AND METHODS

(71) Applicant: Avista Corporation, Spokane, WA (US)

(72) Inventors: Alan Duane Hatfield, College Station, TX (US); Robert James Lafferty, Spokane, WA (US); Gregory William Rahn, Spokane, WA (US)

(21) Appl. No.: 14/842,664

(22) Filed: Sep. 1, 2015

Related U.S. Application Data
(60) Provisional application No. 62/061,615, filed on Oct. 8, 2014.

(51) Int. Cl. B63H 21/38; F17C 6/00; F17C 13/08

(52) U.S. Cl. CPC B63H 21/38; F17C 13/082; F17C 6/00; F17C 2227/041; F17C 2270/0105

(57) ABSTRACT

Liquid fuels are routinely used to provide energy for many different uses. Transferring and distributing liquid fuels have many challenges including providing safe and reliable transfers and distributions. Liquid fuels, for example, Liquid Natural Gas (LNG) may be transferred from a vessel at a relatively low flow rate. This system allows for leaks to be captured and contained to an area of a water based transfer platform rather than allowing the spill to spread out on the surface of the water.

### RELATED APPLICATIONS

This application claims the benefit of U.S. Provisional Application No. 62/061,615 filed on Oct. 8, 2014 which is incorporated by reference herein in their entirety.

### BACKGROUND

Liquid based fuels are used as energy sources by various industries. Transferring and distributing these liquid based fuels can be dangerous. These liquid fuels are increasingly being used in locations that previously did not use the liquid fuels or used them in a smaller amount. Accordingly, there is a need for a system that allows for safe distribution and transfer of liquid fuels to increased locations in increased amounts.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an illustrative water based system for transferring and distributing liquid fuels.

FIG. 2 shows another illustrative water based system for transferring and distributing liquid fuels.

FIG. 3 shows another illustrative water based system for transferring and distributing liquid fuels.

FIG. 4 shows an illustrative water based system for transferring and distributing liquid fuels with multiple vessels.

FIG. 5 shows another illustrative water based system for transferring and distributing liquid fuels with multiple vessels.

FIG. 6 shows an illustrative water based system for transferring and distributing liquid fuels simulating a leak.

FIG. 7 shows the illustrative water based system for transferring and distributing liquid fuels of FIG. 6 simulating the leak at a later time.

FIG. 8 shows an illustrative leak where an embodiment of a spill containment system was not used.

FIGS. 9A-10 are flowcharts of illustrative processes for transferring liquid fuels and containing leaks.

FIGS. 11-17 show additional illustrative water based systems for transferring and distributing liquid fuels with multiple vessels.

### DETAILED DESCRIPTION

### Illustrative Systems

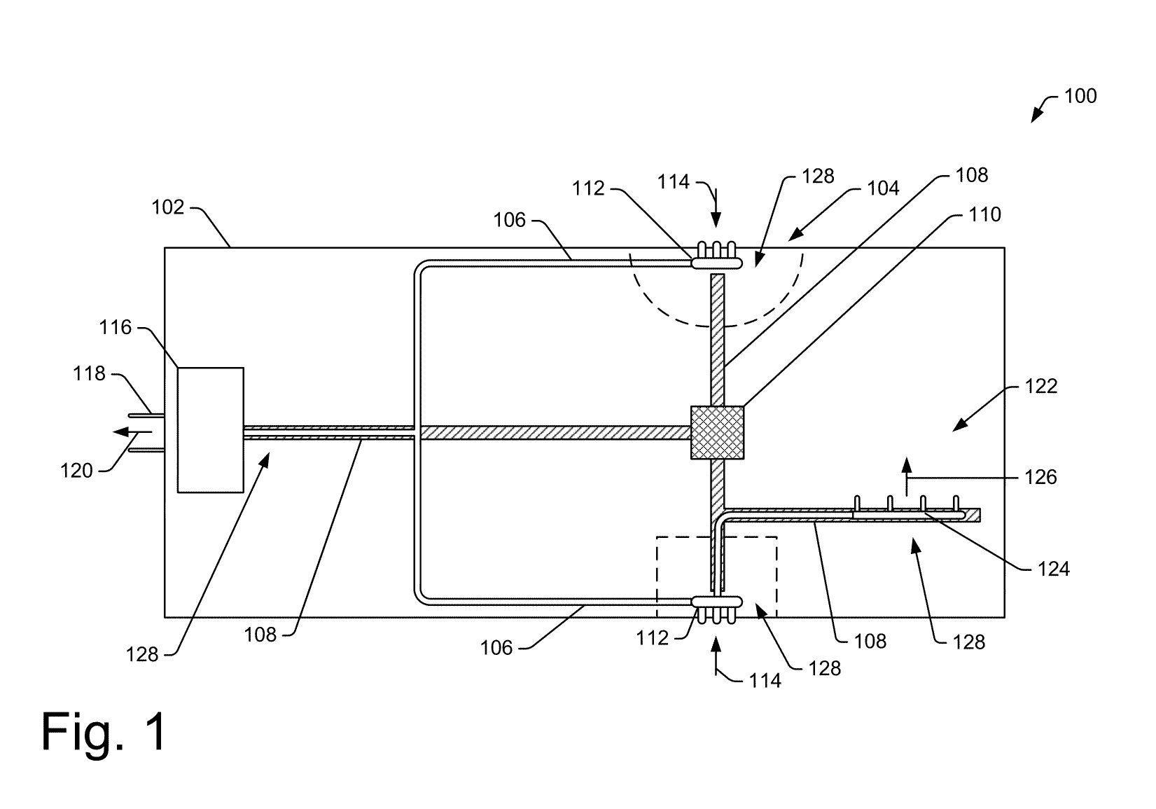

FIG. 1 shows an illustrative water based transfer system 100. Various embodiments contemplate that the water based transfer system 100 may comprise a platform 102 with a spill containment system 104. Various embodiments contemplate that the water based transfer system 100 may be comprise or be located on an offshore jack-up platform, for example a jack-up platform found in the oil and gas production industry. The spill containment system 104 may be configured to collect and in some embodiments hold and or neutralize a liquid spilled from a liquid transfer system 106. Various embodiments contemplate that the spill containment system 104 may comprise collectors 108 and a holding area 110. Various embodiments contemplate that the liquid transfer system 106 may comprise transfer couplings 112. Various embodiments contemplate that liquid may be transferred through the transfer couplings 112 from a source (not pictured) to the liquid transfer system 106 in the direction indicated by arrow 114. Additionally or alternatively, various embodiments contemplate that the liquid may be transferred through transfer coupling 112 from a process management system. Additionally or alternatively, various embodiments contemplate that the liquid may be transferred through transfer coupling 112 in the direction opposite to arrow 114, in the direction of arrow 114, or combinations thereof.

Additionally or alternatively, various embodiments contemplate that the water based transfer system 100 may comprise additional systems. For example, the water based transfer system 100 may include a process management system 116. Various embodiments contemplate that the process management system 116 may comprise pumps, compressors and other equipment that may drive the movement of liquid or a gas, drive various process systems, including gasification systems, vaporization systems, cooling systems, refrigeration systems and/or condensation systems that may change the state of a liquid, or change the state of a gas, or may chemically separate molecules, among other systems. For example, various embodiments contemplate that liquid may be transferred from the water based transfer system 100 to an offsite location, through transfer ports 118 in the direction illustrated by arrow 120. Additionally or alternatively, various embodiments contemplate transferring liquid through ports 118 in a direction opposite to arrow 120, in the direction of arrow 120, or combinations thereof. Additionally or alternatively, various embodiments contemplate that flow through ports 118 may comprise a gas, a liquid, or a combination thereof. Additionally or alternatively, various embodiments contemplate that water based transfer system 100 may comprise one or more liquid storage vessels (not pictured) located on the platform 102, in the platform 102, or combinations thereof.

Various embodiments contemplate that transfer ports 118 may be permanent, semi-permanent, temporary, and/or combinations thereof. For example, various embodiments contemplate that transfer ports 118 may be connected to another location, for example, a distribution site for consumers, for example, at an onshore location. Additionally or alternatively, various embodiments contemplate that transfer ports 118 may be connected to another water based transfer system similar to 100, a storage system, various process systems including gasification systems, vaporization systems, cooling systems, refrigeration systems and/or condensation systems that may change the state of a liquid, or change the state of a gas, or may chemically separate molecules, or combinations thereof among others. Various embodiments contemplate that these connections may be permanent or semi-permanent. For example, various embodiments contemplate that a connection between the water based transfer system 100 and an onshore distribution system may be permanent in the respects that the connection would not be disassembled in the normal course of operation while the water based transfer system 100 is located in a first position. Various embodiments contemplate that the connection may be semi-permanent, for example, when the water based transfer system 100 is moved to a new location, the connection at transfer port 118 may be terminated while the water based transfer system 100 is moved.

Additionally or alternatively, transfer port 118 may be located below the platform 102. Additionally or alternatively, transfer port 118 may be connected to a transfer line that is below the surface of the water, above the surface of the water, at the surface of the water, or combinations thereof.

Additionally or alternatively, various embodiments contemplate that a flow through transfer port 118 may be continuous, intermittent, adjustable, or combinations thereof. For example, various embodiments contemplate that the flow through transfer port 118 may be substantially similar to a usage rate, a distribution rate, a storage rate, or combinations thereof. For example, various embodiments contemplate a demand for a liquid to be at a first rate, where the water based transfer system 100 may supply the liquid at a second rate where the first rate and second rate are within a threshold limit. For example, a demand for a liquid may be on average 200 cubic meters of liquid per hour where the liquid may be supplied at an average rate of 200 cubic meters of liquid plus or minus a threshold amount. This may be an example of supplying the liquid at a usage rate. In an example case where the liquid is liquid natural gas (LNG) the LNG may be gasified at approximately this rate and transferred to end users. Additionally or alternatively, various embodiments contemplate that the liquid may be transferred at a distribution rate, where, for example, the liquid may be transferred off of the water based transfer system 100 to another transfer system that may be water based, land based, or combinations thereof and further distributed to users, storage, or transfer systems. The distribution rate may or may not be tied directly to a consumption rate. Additionally or alternatively, various embodiments contemplate that the liquid may be transferred at a storage rate, where for example, the liquid may be transferred off of the water based transfer system 100 to a storage system that may be water based, land based, or combinations thereof. This rate may or may not be tied directly to a consumption rate or a distribution rate.

Additionally or alternatively, various embodiments contemplate that water based transfer system 100 may further comprise a distribution system 122. Various embodiments contemplate that distribution system 122 may comprise transfer port 124. Various embodiments contemplate that liquid may be transferred through the transfer port 124 from the liquid transfer system 106 to a storage system (not pictured) in the direction indicated by arrow 126. Additionally or alternatively, various embodiments contemplate that the liquid may be transferred through transfer port 124 in the direction opposite to arrow 126, in the direction of arrow 126, or combinations thereof.

Various embodiments contemplate that platform 102 may comprise a structure that extends below the surface of the water. For example, various embodiments contemplate that platform 102 may comprise a floating platform, a fixed platform, where the platform has structure attaching it to the floor below the platform, a compliant tower that may allow lateral movement, a vertically moored tension leg and/or mini-tension leg platform, a spar configuration, a semi-submersible, a jack up system where a platform may be jacked up onto legs extending to the floor below the platform, or combinations thereof.

Various embodiments contemplate that the spill containment system 104 may comprise collectors 108 and a holding area 110. Additionally or alternatively, various embodiments contemplate that the collectors 108 may comprise a channel in the platform. For example, the channel may be configured to collect and direct liquid to the holding area 110. Additionally or alternatively, various embodiments contemplate that the channel may comprise a trench. Additionally or alternatively, various embodiments contemplate that the collector 108 may be covered by a permeable cover that may prevent workers and or equipment from inadvertently entering the collector 108. Various embodiments contemplate that the permeable cover may comprise a grate. Various embodiments contemplate that the collector 108 may utilize various techniques to direct any collected liquid. For example, various embodiments contemplate providing a slope along a portion of the collector 108 to direct any collected liquid to the holding area 110. Various embodiments contemplate that the slope may comprise an incline sufficient to move a captured liquid at a spill transfer rate. Various embodiments contemplate that the spill transfer rate may achieve a flow rate of the captured liquid to the holding area 110 faster than an evaporation rate of the spilled liquid. Various embodiments contemplate that the spill transfer rate may be at least twice as fast as the evaporation rate of the spilled liquid. Various embodiments contemplate that the spill transfer rate may be at least 10 times as fast as the evaporation rate of the spilled liquid. Various embodiments contemplate that the spill transfer rate may be at least 100 times as fast as the evaporation rate of the spilled liquid. Various embodiments contemplate that the spill transfer rate may be at least 1000 times as fast as the evaporation rate of the spilled liquid.

Additionally or alternatively, various embodiments contemplate that the holding area 110 may comprise a holding cavity disposed in the surface of the platform. For example, the holding cavity may provide a volumetric space where collected spilled liquid may be collected, stored, and/or disposed of. For example, the holding cavity may comprise a sump and or a pit where captured liquid may accumulate. Various embodiments contemplate that a holding area 110 may be configured to allow a captured liquid to evaporate, weather off, disperse in a controlled manner, be collected, be contained, or combinations thereof. Various embodiments contemplate that the holding area 110 may be configured to allow a captured liquid to evaporate, weather off, disperse in a controlled manner, be collected, be contained, or combinations thereof at a desired rate. For example, a given leak rate and duration of a leak, a volume of spilled liquid may be determined. The holding area 110 may be configured to allow a captured liquid to evaporate within a spill evaporation threshold. Depending on the type and nature of the captured liquid, various embodiments contemplate that the spill evaporation threshold is 12 hours. Depending on the type and nature of the captured liquid, various embodiments contemplate that the spill evaporation threshold is 24 hours. Depending on the type and nature of the captured liquid, various embodiments contemplate that the spill evaporation threshold is 36 hours. Depending on the type and nature of the captured liquid, various embodiments contemplate that the spill evaporation threshold is 48 hours.

As a non-limiting example, if a captured liquid is LNG, then the holding area 110 may be configured to allow a collected spill to evaporate within a spill evaporation threshold. Various embodiments contemplate that the spill evaporation threshold is 1 minute. Various embodiments contemplate that the spill evaporation threshold is 5 minutes. Various embodiments contemplate that the spill evaporation threshold is 7 minutes hours. Various embodiments contemplate that the spill evaporation threshold is 10 minutes. Various embodiments contemplate that the spill evaporation threshold is 20 minutes. Various embodiments contemplate that the spill evaporation threshold is 30 minutes. Various embodiments contemplate that the spill evaporation threshold is 60 minutes.

Additionally or alternatively, various factors may affect the configuration of the holding area. Various embodiments contemplate that a size of a gas cloud from a spill be minimized and the duration of the cloud of gases be minimized. However, these factors are often inversely related. For example, a balance may be struck between the size and distribution of a resulting cloud of gases caused by a spill and the duration of the cloud of gases. For example, for a given spill volume, if the size of the cloud of gases is to be reduced, then, the duration of the cloud of gases increases. Similarly, if the duration of the cloud of gases is to be reduced, then the size of the cloud increases. The size of the cloud may be influenced by multiple factors. For example, the surface area of the liquid in the holding area 110 may influence the size and duration of the cloud. For example, a shallow wide holding area 110 may provide for relatively quick evaporation, but a relatively large gas cloud. Additionally or alternatively, a deep narrow holding area 110 may provide for a relatively small and contained gas cloud that may last a relatively longer period of time.

Additionally or alternatively, various embodiments contemplate that the size and slope of the collectors 108 may also influence the size and duration of a gas cloud. For example, a narrow steeply sloped collector 108 may rapidly direct and move the spilled liquid towards the holding area 110 allowing the spill to collect and concentrate the spilled liquid. This may cause the cloud size to be relatively small, while the duration of the cloud may be relatively long. Additionally or alternatively, if the collectors 108 are relatively wide with a slight slope, then the spilled liquid might not be transferred to the holding area 110 as quickly. This may cause the duration of the cloud to be relatively short, but may cause the cloud to be relatively large.

Additionally or alternatively, various additional factors may affect the size and duration of the gas cloud. For example, wind, temperature, and other atmospheric conditions may increase or decrease the relative size and duration of the gas cloud. For example, a relatively higher wind may aid in the dispersement and increased evaporation rate of the gas cloud. Additionally or alternatively, the location and positioning of structures and vessels on and around the platform 102 may affect the wind's ability to aid in the dispersement of the cloud of gases.

Additionally or alternatively, the location of structures, vessels, and other aspects of the platform 120 and adjoining environments may influence the desired balance. For example, if vessels and structures are relatively close and relatively vulnerable to the gas cloud, for example, if the gas is corrosive and/or combusting, then reducing the relative size of the cloud may be more important than reducing the duration of the cloud.

Additionally or alternatively, various embodiments contemplate integrating additional safety measures and systems, for example, sensors, shutoff valves, and emergency shutdown systems may be used to sense a leak and stop the flow of liquid in a relatively short period of time. Various embodiments contemplate that shut-off valves may comprise devices located in series with pipes that transfer liquid or gas that can be closed to stop the flow of liquid or gas in either an emergency or normal operating situation. Such values may be integrated into an emergency shutdown system that may automatically shut valves when certain sensors detect abnormal conditions.

Additionally or alternatively, the collection of a spill, spill transfer rate, and spill evaporation threshold may be based at least in part on a transfer rate from one or more sources transferred through the liquid transfer system 106 for example, through one or more transfer couplings 112.

While modern liquid handling systems improve reliability and toughness, there remains a possibility of a leak. As such, in the unlikely event of a leak, various embodiments contemplate locating a portion of a collector 108, for example, an edge of a trench near, adjacent to, directly under, or combinations thereof a likely location of a leak. For example, a location near a junction may have a higher likelihood of experiencing a leak than a location away from a junction might have. For example, areas 128 may be located near junctions of the liquid transfer system 106.

Additionally or alternatively, various embodiments contemplate that the spill containment system 104 may comprise an elevated containment element, for example, a dike, a lip, a berm, a curb, or combinations thereof. Various embodiments contemplate that the elevated containment element may be configured to contain a spill to the platform 102. For example, the elevated containment element may be located at regions near the edge of the platform 102. Additionally or alternatively, the elevated containment feature may be located near areas 128 to further keep a spill adjacent to or directed to a portion of collector 108. Various embodiments contemplate that areas 128 may comprise a berm or elevated area around a perimeter, a sloped surface providing a grade directing a spill towards a portion of collector 108, or a combination thereof.

Additionally or alternatively, various embodiments contemplate that platform 102 may have a surface in which collectors 108 and holding area 110 are disposed. Various embodiments contemplate that a portion of the surface slopes towards a portion of a collector 108. Various embodiments contemplate that the slope in the surface of the platform 102 may be localized to one or more areas 128. Various embodiments contemplate that the slope in the surface may aid in directing a spilled liquid towards a collector 108.

Various embodiments contemplate that a portion of the spill containment system 104 may comprise various materials. For example, a portion of a collector 108 may comprise a material that does not react with the spilled liquid. Additionally or alternatively, various embodiments contemplate that the material may provide beneficial handing characteristics. For example, the material may be able to handle a thermal load caused by the liquid coming into contact with the material. Additionally or alternatively, the material may be configured to limit the amount of thermal load transferred to or from the spilled liquid. In the non-limiting example where LNG is the liquid, a portion of the collector 108, for example the walls of a trench, may comprise one or more of an insulated and/or aerated concrete, aluminum, aluminum alloys, stainless steel, various polymers, or combinations thereof.

Various embodiments contemplate that the liquid transferred may comprise various liquids. For example, the liquids may include, but are not limited to, hazardous and/or non-hazardous materials. For example, a hazardous material may include acids, bases, and/or liquid fuels. For example, liquid fuels may include earth storable liquid fuels, cryogenic liquid fuels, or combinations thereof. Additionally or alternatively, cryogenic liquid fuels may include, but are not limited to, liquid natural gas, liquid oxygen, liquid hydrogen, or combinations thereof, among others. Earth storable liquid fuels may comprise oils and/or hydrocarbons, for example, methane, ethane, propane, butane, pentane, hexane, alkenes and isomeric cycloalkanes, gasoline, naphtha, jet fuel, or combinations thereof. Various embodiments contemplate that non-hazardous materials may comprise oils, and other liquid chemicals.

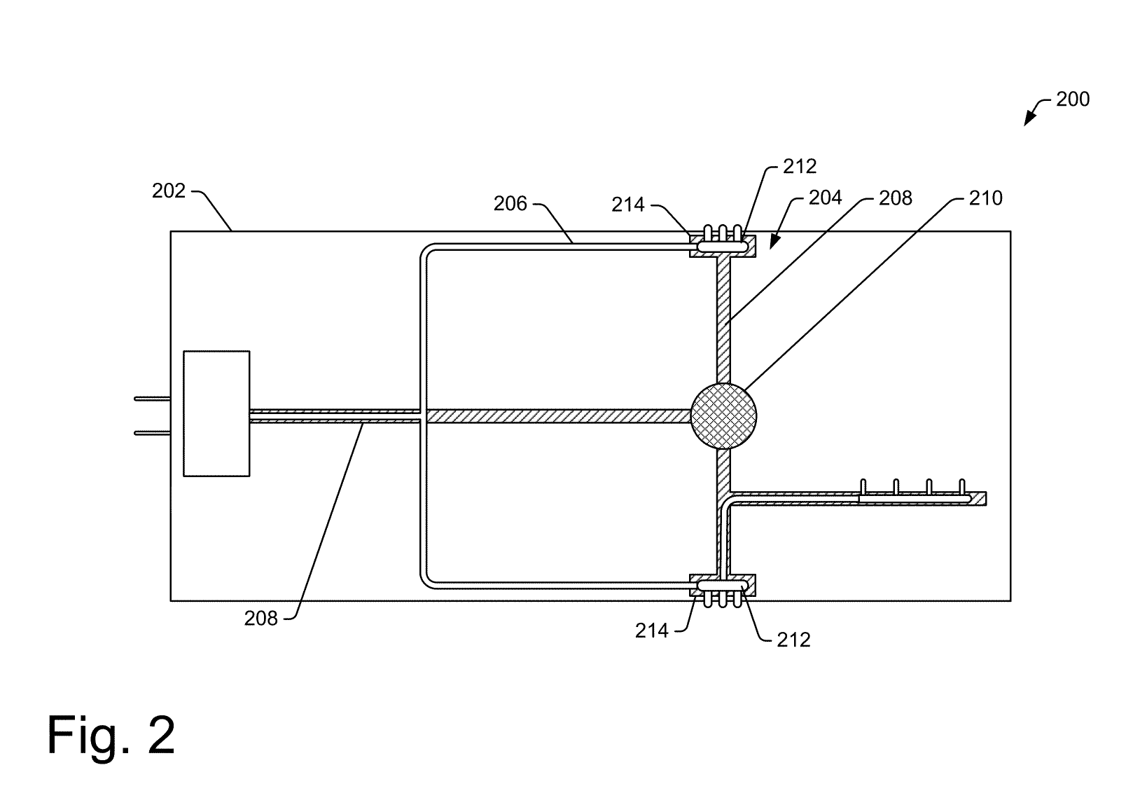

FIG. 2 shows an illustrative water based transfer system 200. Various embodiments contemplate that the water based transfer system 200 may comprise a platform 202 with a spill containment system 204. The spill containment system 204 may be configured to collect and in some embodiments hold and or neutralize a liquid spilled from a liquid transfer system 206. Various embodiments contemplate that the spill containment system 204 may comprise collectors 208 and a holding area 210. Various embodiments contemplate that the liquid transfer system 206 may comprise transfer couplings 212. Various embodiments contemplate that liquid may be transferred through the transfer couplings 212 from a source (not pictured) to the liquid transfer system 206. Various embodiments contemplate that collectors 208 may have a portion 214 that may be a disposed adjacent to, underneath, or combinations thereof a portion of the liquid transfer system 306. For example, portion 214 may be located below an area that may have a relatively higher likelihood of a leak than another portion of the liquid transfer system. For example, portion 214 may be located directly below one or more transfer couplings 212.

FIG. 2 also shows holding area 210. Various embodiments contemplate that holding area 210 may be cylindrical, hemispherical, or combinations thereof. Various embodiments contemplate that holding area 210 may be other geometrical shapes or configurations. Additionally or alternatively, various embodiments contemplate that holding area 210 is configured to accumulate and hold a liquid spilled on platform 202.

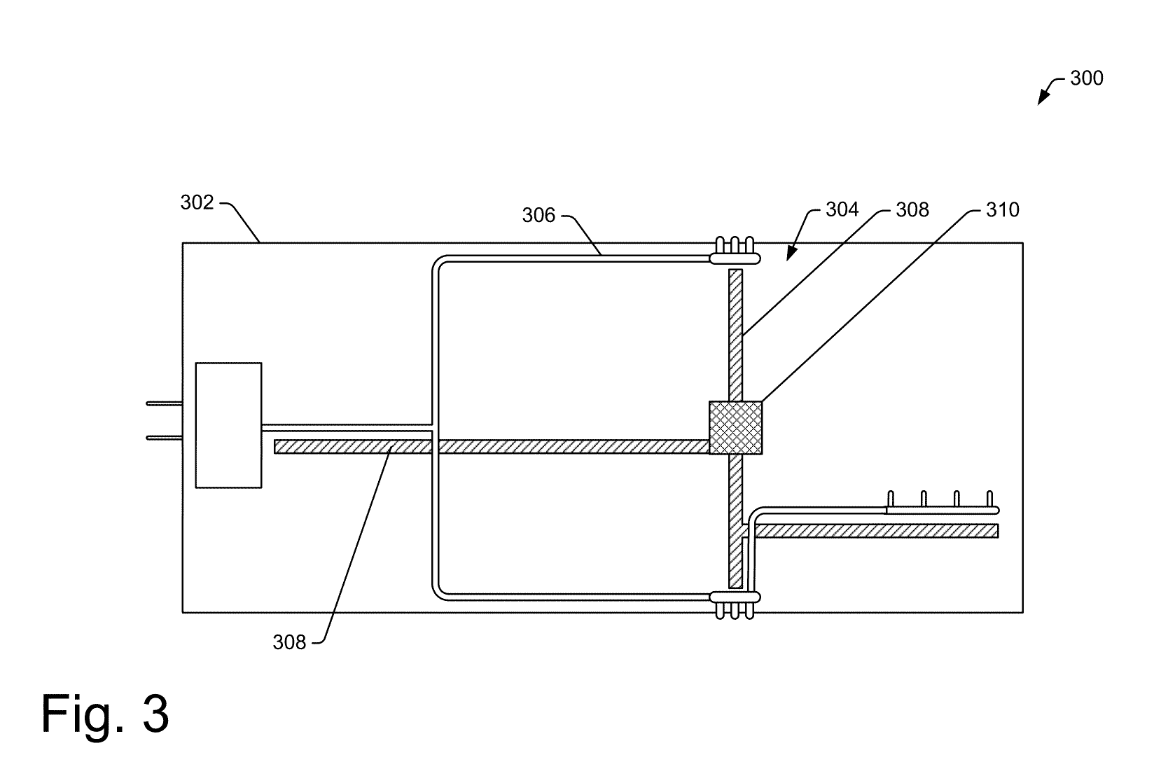

FIG. 3 shows an illustrative water based transfer system 300. Various embodiments contemplate that the water based transfer system 300 may comprise a platform 302 with a spill containment system 304. The spill containment system 304 may be configured to collect and in some embodiments hold and or neutralize a liquid spilled from a liquid transfer system 306. Various embodiments contemplate that the spill containment system 304 may comprise collectors 308 and a holding area 310. Various embodiments contemplate that collectors 308 may have a portion of collectors 308 substantially adjacent to a portion of the liquid transfer system 306. For example, FIG. 3 shows substantial portions of collectors 308 placed adjacent to portions of the liquid transfer system 306. Additionally or alternatively, FIG. 3 shows portions of collectors 308 directly under liquid transfer system 306 in limited locations, for example, when a collector 308 crosses under a portion of the liquid transfer system 306 at a non-collinear angle. Various embodiments contemplate that a collector 308 is limited to crossing under a portion of the liquid transfer system 306 at a substantially right angle. Various embodiments contemplate several possible benefits of this illustrative configuration. For example, support structure for the liquid transfer system 306 may be more easily mounted to the platform 302 if a collector 308, for example, a trench is not directly below the support structure. Additionally or alternatively, if a spill is collected by collector 306, and the spill is somehow ignited, any flames from the flammable liquid in the collector 306 may have a higher likelihood of not impinging directly on the liquid transfer system 306.

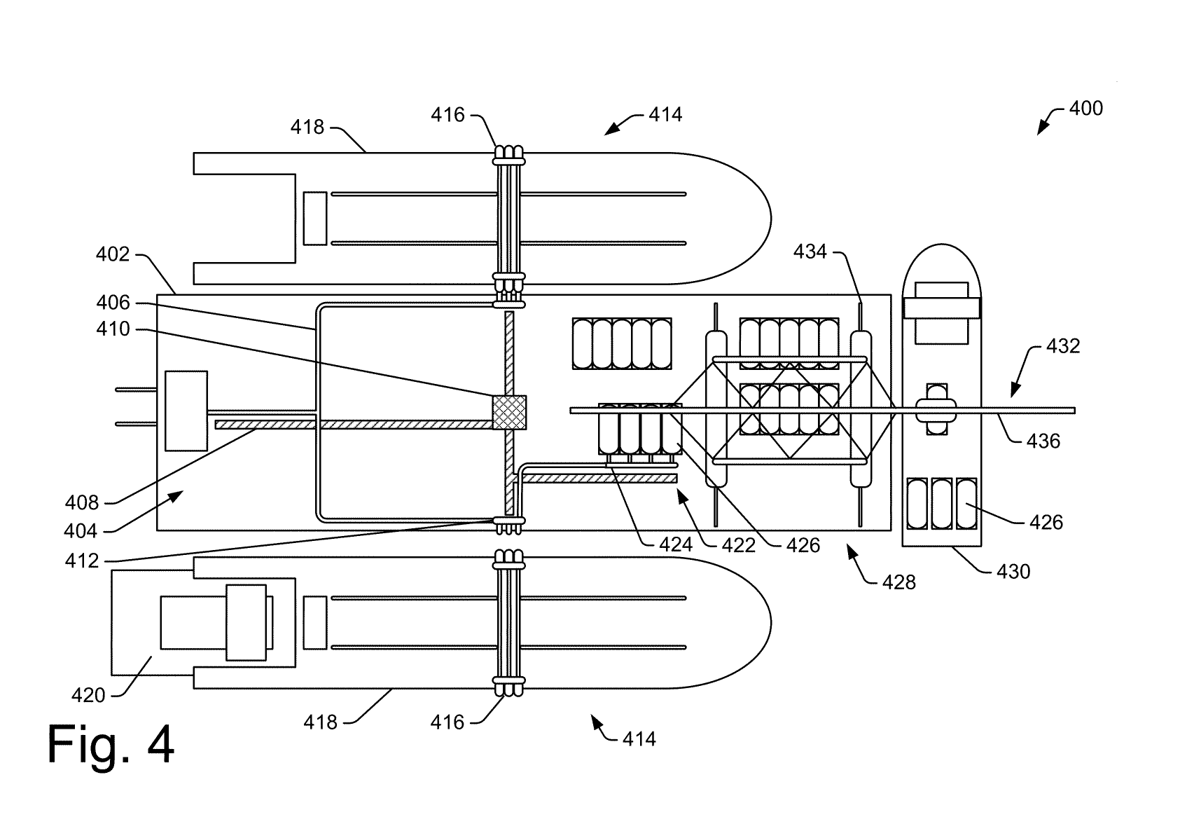

FIG. 4 shows an illustrative water based transfer system 400. Various embodiments contemplate that the water based transfer system 400 may comprise a platform 402 with a spill containment system 404. The spill containment system 404 may be configured to collect and in some embodiments hold and or neutralize a liquid spilled from a liquid transfer system 406. Various embodiments contemplate that the spill containment system 404 may comprise one or more collectors 408 and one or more holding areas 410. Various embodiments contemplate that the liquid transfer system 406 may comprise transfer couplings 412. Various embodiments contemplate that liquid may be transferred through the transfer couplings 412 from a source, for example a vessel 414, to the liquid transfer system 406.

Various embodiments contemplate that the vessel 414 may interface with the liquid transfer system 406 through transfer couplings 416. Various embodiments contemplate that vessel 414 may include, but is not limited to, a ship, a barge, a storage tank, or combinations thereof. Various embodiments contemplate vessel 414 acting as a supply vessel as well as a storage container. For example, various embodiments contemplate that the vessel 414 may be filled with the liquid at a different location and transported to the water based transfer system 400. After the vessel 414 reaches water based transfer system 400, the vessel 414 may be connected to the liquid transfer system 406 and may supply liquid on an as needed basis. For example, liquid transfer system 406 may be connected as a supplying source to a system, for example, a natural gas pipeline. In this example, the natural gas pipeline system may have a demand associated with the pipeline. Various embodiments contemplate that the vessel 414 may supply a portion or all of natural gas to meet the demand as the demand occurs. In this example, the vessel 414 may act as a storage system if the rate of the demand is below the offload rate capabilities of the vessel 414 and/or liquid transfer system 406.

FIG. 4 also shows an example of a vessel 414 that may comprise multiple sections. For example, vessel 414 may have a storage section 418 and a propulsive section 420. Various embodiments contemplate that the storage section 418 may be separated from the propulsive section 420. For example, various embodiments contemplate that vessel 414 may comprise an articulated tug barge (ATB). Additionally or alternatively, various embodiments contemplate that the storage section 418 remains connected to propulsive section 420 while vessel 414 provides a storage function.

Additionally or alternatively, various embodiments contemplate a mooring system. For example, a mooring system may be anchored into the seabed and provide support to a ship or an ATB while the ship or ATB is interacting with the water based transfer platform. The mooring system may be anchored to the seabed and be independent from or connected to the platform. The mooring system may provide protection to the platform from external forces including for example, but not limited to, collisions from other ships or floating structures.

Additionally or alternatively, various embodiments contemplate that water based transfer system 400 may further comprise a distribution system 422. Various embodiments contemplate that distribution system 422 may comprise transfer port 424. Various embodiments contemplate that liquid may be transferred through the transfer port 424 from the liquid transfer system 406 to one or more storage systems 426. Various embodiments contemplate that a storage system 426 comprises self-contained pressurized (or unpressurized) storage tanks, for example, a tank built to applicable ISO standards (ISO container), for example, a vessel that provides a boil-off capacity, for example a “C-tank.” Various embodiments contemplate that storage system 426 comprises an off platform storage system, for example, a bunkering system.

FIG. 4 also shows a storage system 426 management system 428. Various embodiments contemplate that management system 428 may facilitate the filling of one or more storage systems 426 through liquid transfer system 406 and 422, for example, from vessel 414. Various embodiments contemplate management system 428 may facilitate the storage of empty and filled storage systems 426. Additionally or alternatively, various embodiments contemplate management system 428 facilitating the loading and unloading of full and/or empty storage systems 426 from a transport vessel 430. Various embodiments contemplate that transport vessel 430 may be configured to deliver storage systems 426 to locations desiring the liquid. For example, when the liquid is LNG, various embodiments contemplate delivering LNG in ISO containers to locations desiring natural gas where it may be impractical to supply natural gas through a pipeline and/or or a natural gas pipeline is unavailable.

Additionally or alternatively, various embodiments contemplate transferring liquid from one or more storage systems 426 to one or more additional storage systems 426, one or more transfer ports, transfer couplings 412 to a vessel 414, or combinations thereof.

Additionally or alternatively, various embodiments contemplate that management system 428 may comprise a storage system 426 movement system 432, for example, a crane, one or more carts, trucks, slides, combinations thereof, among others. Various embodiments contemplate that movement system 432 may be configured to move in a direction substantially parallel to an axis of the transport vessel 430, for example, along tracks 434. Additionally or alternatively, various embodiments contemplate that movement system 432 may be configured to move in a direction substantially perpendicular to an axis of the transport vessel 430, for example, along gantry 436.

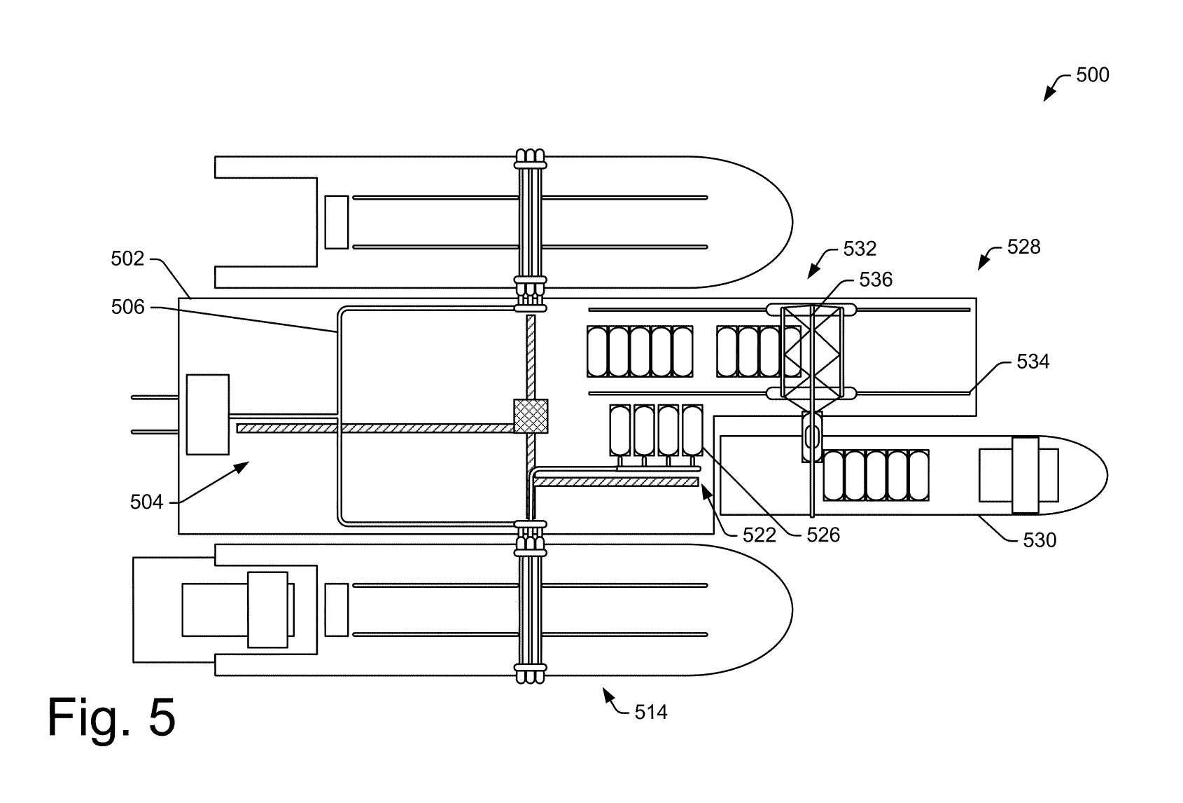

FIG. 5 shows an illustrative water based transfer system 500. Various embodiments contemplate that the water based transfer system 500 may comprise a platform 502 with a spill containment system 504. The spill containment system 504 may be configured to collect and in some embodiments hold and or neutralize a liquid spilled from a liquid transfer system 506. Various embodiments contemplate that liquid may be transferred through the liquid transfer system 506 from a source, for example a vessel 514.

Additionally or alternatively, various embodiments contemplate that water based transfer system 500 may further comprise a distribution system 522. Various embodiments contemplate that distribution system 522 may transfer liquid from the liquid transfer system 506 to one or more storage systems 526.

FIG. 5 also shows a storage system 526 management system 528. Various embodiments contemplate that management system 528 may facilitate the filling of one or more storage systems 526 through liquid transfer system 506, for example, from vessel 514. Various embodiments contemplate management system 528 may facilitate the storage of empty and filled storage systems 526. Additionally or alternatively, various embodiments contemplate management system 528 facilitating the loading and unloading of full and/or empty storage systems 526 from a transport vessel 530. Various embodiments contemplate that transport vessel 530 may be configured to deliver storage systems 526 to locations desiring the liquid. For example, when the liquid is LNG, various embodiments contemplate delivering LNG in ISO containers to locations desiring natural gas where it may be impractical to supply natural gas through a pipeline and/or or a natural gas pipeline is unavailable.

Additionally or alternatively, various embodiments contemplate that management system 528 may comprise a storage system 526 movement system 532, for example, a crane, one or more carts, trucks, slides, combinations thereof, among others. Various embodiments contemplate that movement system 532 may be configured to move in a direction substantially parallel to an axis of the transport vessel 530, for example, along tracks 534. Additionally or alternatively, various embodiments contemplate that movement system 532 may be configured to move in a direction substantially perpendicular to an axis of the transport vessel 530, for example, along gantry 536.

### Example Spill Containment

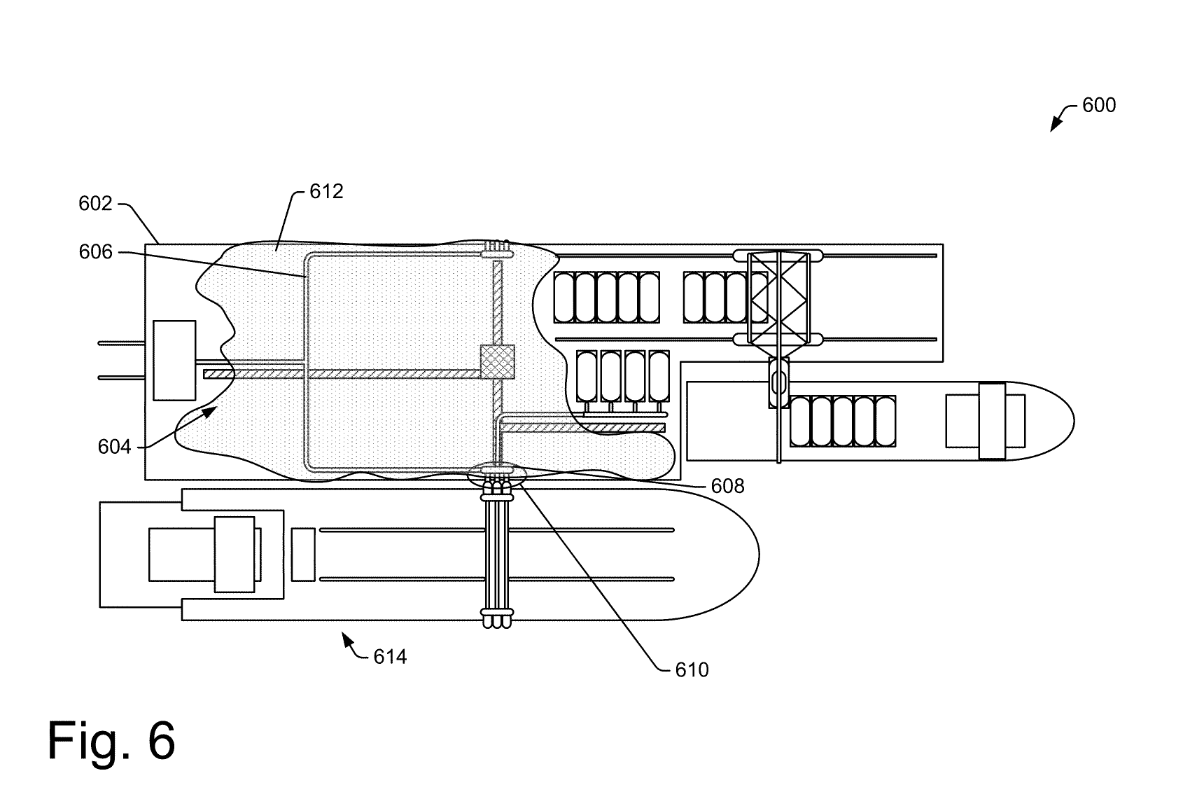

FIG. 6 shows an illustrative spill of a liquid from an illustrative water based transfer system 600. Various embodiments contemplate that the water based transfer system 600 may comprise a platform 602 with a spill containment system 604. The spill containment system 604 may be configured to collect and in some embodiments hold and or neutralize a liquid spilled from a liquid transfer system 606. Various embodiments contemplate that liquid may be transferred through the liquid transfer system 606 from a source, for example a vessel 614.

FIG. 6 shows an illustrative spill 608 originating at a transfer point 610 between the liquid transfer system 606 and vessel 614. Various embodiments contemplate that the liquid spill comprises a cryogenic liquid. Often, when a cryogenic liquid is released into atmospheric conditions, the cryogenic liquid may begin to evaporate into a gas and may form a gas cloud 612. FIG. 6 shows an illustrative example, where the liquid comprises LNG and gas cloud 612 comprises natural gas.

The spill in FIG. 6 is modeled as a spill at a flow rate similar to an expected average flow rate from the vessel 614 to the liquid transfer system 606 where the spill lasts for 10 minutes. The gas cloud 612 is illustrative of a natural gas cloud that would be formed by a spill of LNG, where the still liquid LNG is collected and contained by the spill containment system 604. Various embodiments contemplate that the resulting gas cloud 612 may be contained to the immediate vicinity of the platform 602 if not the platform 602 itself.

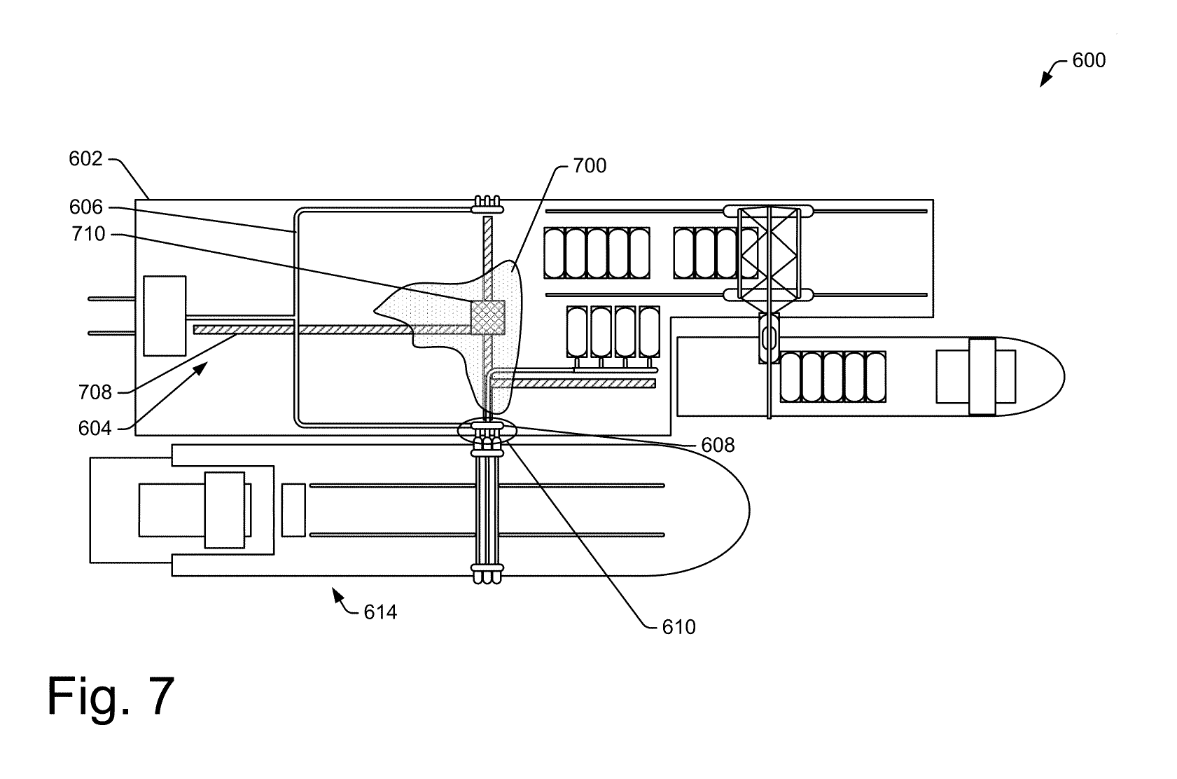

FIG. 7 shows the illustrative water based transfer system 600 at a later time where the liquid spill has been collected by collectors 708 and directed to holding area 710. Various embodiments contemplate that the resulting gas cloud 700 is now contained within the platform 602 and does not extend beyond the perimeter of the platform 602.

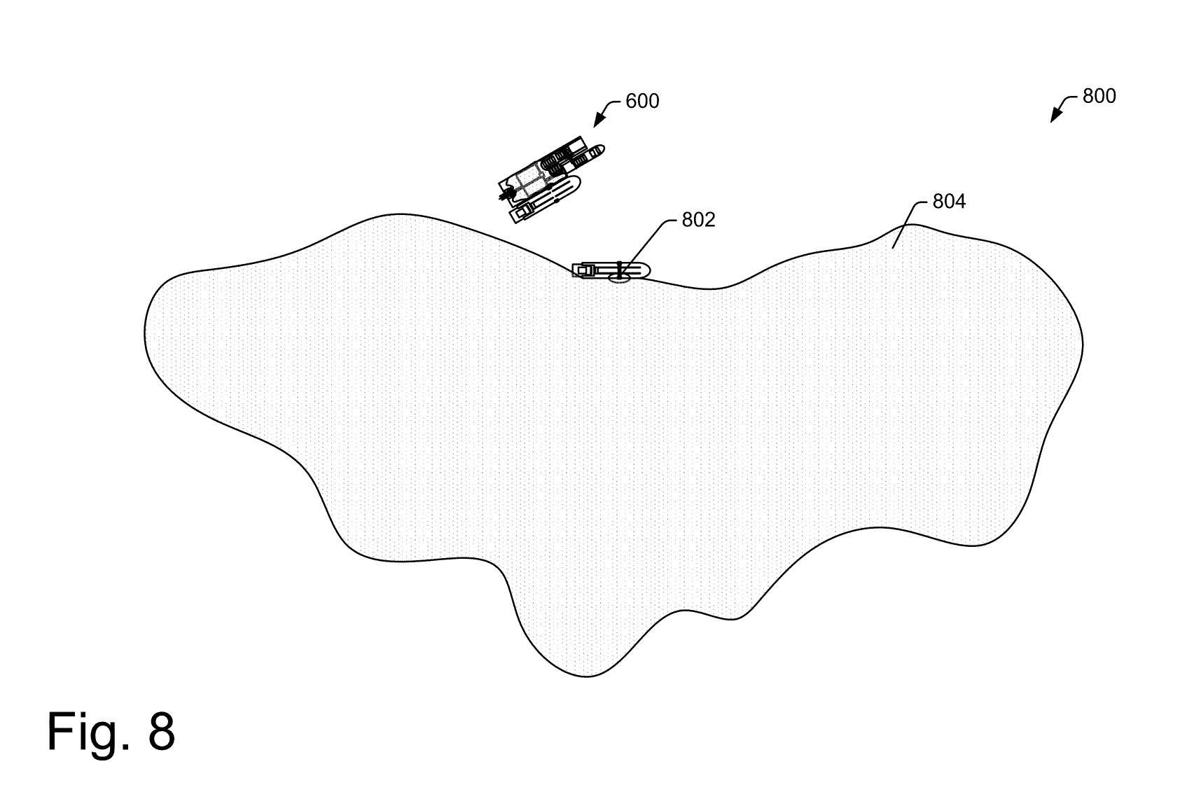

FIG. 8 shows an illustrative liquid transfer system 800 with a spill 802 analogous to the spill discussed with respect to FIGS. 6 and 7. However, FIG. 8 shows an example where the spill is not contained by a spill containment system and is allowed to disperse across the water as some water based liquid transfer systems allow. For example, FIG. 8 shows the spill 802 resulting in a gas cloud 804 that spreads well beyond the immediate vicinity of the vessel spilling the liquid. FIG. 8 also shows liquid transfer system 600 as discussed with respect to FIGS. 6 and 7. The size of the gas cloud 804 is many times larger than the gas cloud 612 for a spill of the same size.

Various embodiments contemplate that if the liquid causes the gas cloud to be dangerous, for example, if the gas cloud is toxic, combustible, or combinations thereof, the area affected by a spill contained by a spill containment system may be orders of magnitude smaller than an affected area by a similar spill that is not contained. This may be especially important where the water based transfer system is close to land or other structures. For example, if the water based transfer system is located in a bay or harbor, the affected area of a spill that is not contained may reach the shore and may cause injury to people and/or property.

Various embodiments contemplate that the transfer rate between a vessel and a water based transfer system may comprise a wide range of flow rates. For example, the flow rate may be tied to a consumption rate, for example, where the consumption rate is lower than the on-loading and off-loading capabilities of the vessel and/or the liquid transfer system. For example, various embodiments contemplate that a vessel may be loaded at a transfer rate of between 2,000 and 3,000 cubic meters per hour. Various embodiments contemplate that a vessel may be loaded at a transfer rate of between 10,000 and 12,000 cubic meters per hour. An example of loading a vessel at one or more of these transfer rates may take place, for example at the liquid production location. For example, if the liquid is LNG, the LNG may be loaded onto the vessel at an LNG production location. Additionally or alternatively, if the vessel is an ATB, then the transfer rate may be between 2,000 and 3,000 cubic meters per hour. Additionally or alternatively, if the vessel is a large LNG transport ship, the transfer rate may be between 10,000 and 12,000 cubic meters per hour.

Various embodiments contemplate that a liquid transfer system may be fed by a vessel at a transfer rate of between 20 and 50 cubic meters per hour. Various embodiments contemplate that a liquid transfer system may be fed by a vessel at a transfer rate of between 50 and 500 cubic meters per hour. Various embodiments contemplate that a liquid transfer system may be fed by a vessel at a transfer rate of between 500 and 1,000 cubic meters per hour. Various embodiments contemplate that a liquid transfer system may be fed by a vessel at a transfer rate of between 1,000 to 2,000 cubic meters per hour. Various embodiments contemplate that a liquid transfer system may be fed by a vessel at a transfer rate of between 2,000 and 3,000 cubic meters per hour. Various embodiments contemplate that a liquid transfer system may be fed by a vessel at a transfer rate of between 20 and 3,000 cubic meters per hour.

Various embodiments contemplate that a vessel may be loaded in approximately 12 hours. Various embodiments contemplate that a vessel may be off loaded by the liquid transfer system over the course of approximately 6 days.

Additionally or alternatively, a spill containment system may be configured to handle a spill of a certain size. For example, a size of a spill may be determined based on a flow rate and a spill time. Various embodiments contemplate that a spill may last from zero to approximately 20 minutes. Various embodiments contemplate a spill lasting approximately 10 minutes. Additionally or alternatively, various embodiments contemplate a spill flow rate may comprise the offload rate from the vessel to the liquid transfer system. Additionally or alternatively, various embodiments contemplate integrating additional safety measures and systems, for example, sensors, shutoff valves, and emergency shutdown systems may be used to sense a leak and stop the flow of liquid in a relatively short period of time. However, in the event of a failure of such a system, a leak time and resulting amount may be increased to approximate times discussed above.

Various embodiments contemplate that features of the spill containment system may be sized to accommodate an expected spill size. For example, the holding area may be sized to hold the spill until it is neutralized. As discussed above, various factors may influence the size and configuration of the spill containment system. For example, a given spill rate and duration may produce a given spill volume. The characteristics of the spill liquid, including for example, evaporation rate, viscosity, among others may influence the size and duration of a resulting gas cloud. Additionally or alternatively, wind may influence how quickly the gas cloud dissipates.

For example, given a 300 cubic meters per hour spill rate of LNG, various embodiments contemplate that a sump may be approximately 18 ft by 18 ft by 14 ft deep. This may produce a gas cloud that may be substantially limited to the area of the platform and may have a duration of less than 10 minutes. Various embodiments contemplate that a sump may be approximately 10 ft by 10 ft by 45 ft deep. This may produce a gas cloud that may be substantially limited to an area within the platform and may have a duration of greater than 20 minutes. Various embodiments contemplate that this may allow the gas cloud to avoid structures or vessels adjacent to or on the platform. Various embodiments contemplate that a trench may be approximately 3 ft wide by 1 ft deep and may be sloped towards a sump.

### Illustrative Processes

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

The processes are illustrated as a collection of blocks in logical flowcharts, which represent a sequence of operations. For discussion purposes, the processes are described with reference to the system shown in FIGS. 1-8 and 11-13. However, the processes may be performed using different architectures and systems.

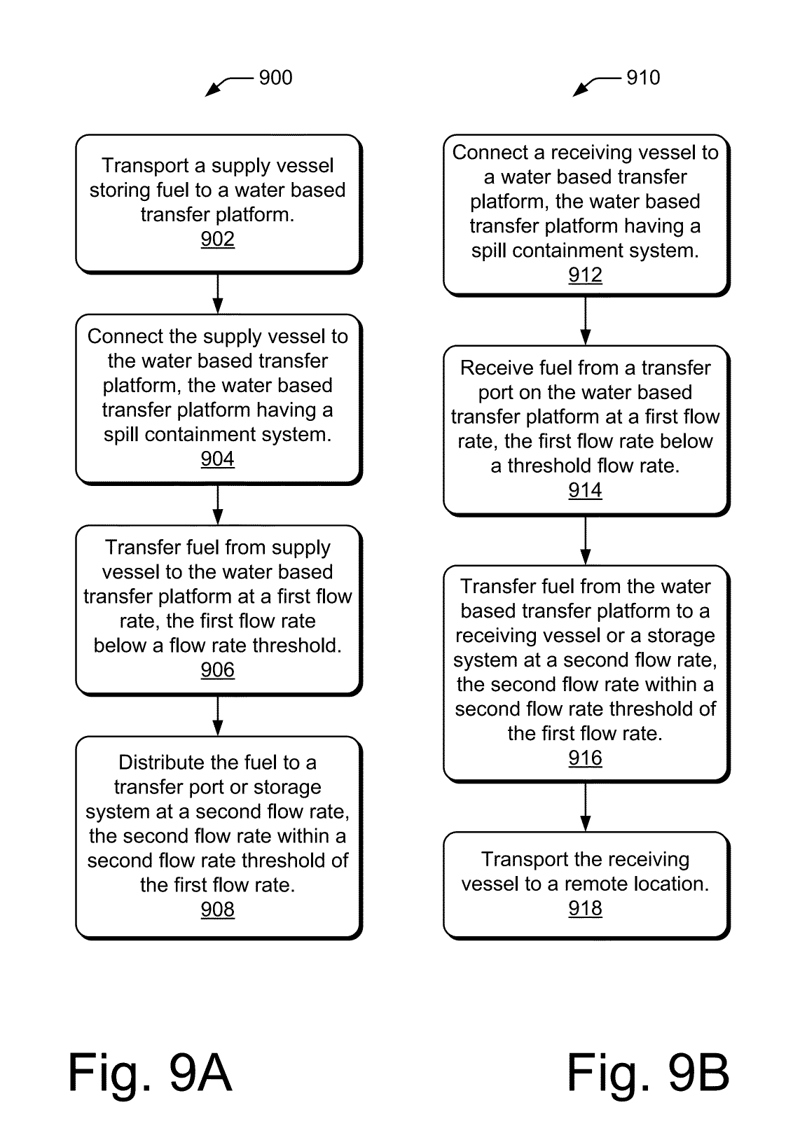

FIG. 9A shows a method 900 where, a transport supply vessel may store and supply fuel to a water based transfer platform at 902. For example, the transport supply vessel may connect to a liquid transfer system of the water based transfer platform.

At 904, the supply vessel may connect to the water based transfer platform where the water based transfer platform may have a spill containment system.

At 906, a liquid, for example a fuel, may be transferred from the supply vessel to the water based transfer platform at a first flow rate, where the first flow rate is below a flow rate threshold. For example, the flow rate threshold may be substantially lower than an on loading flow rate.

At 908, the liquid, for example, fuel, may be distributed to a transfer port or to a storage system at a second flow rate, where the second flow rate is within a second flow rate threshold of the first flow rate. For example, the second flow rate may be substantially similar to and/or match the first flow rate. Additionally or alternatively, the second flow rate may be substantially greater than the first flow rate. Additionally or alternatively, the second flow rate may be substantially less than the first flow rate. Various embodiments contemplate distributing fuel to consumers directly or through various storage systems and transfers.

FIG. 9B shows a method 910 where a receiving vessel is connected to a water based transfer platform where the water based transfer platform may have a spill containment system at 912.

At 914, the water based transfer platform may receive fuel, in gaseous or liquid state, from a transfer port at a first flow rate. The first flow rate may be below a threshold flow rate.

At 916, fuel may be transferred from the water based transfer platform to a receiving vessel or a storage system at a second flow rate. The second flow rate may be within a second flow rate threshold of the first flow rate.

At 918, the receiving vessel may be disconnected from the water based transfer platform and transported to a location remote from the water based transfer platform.

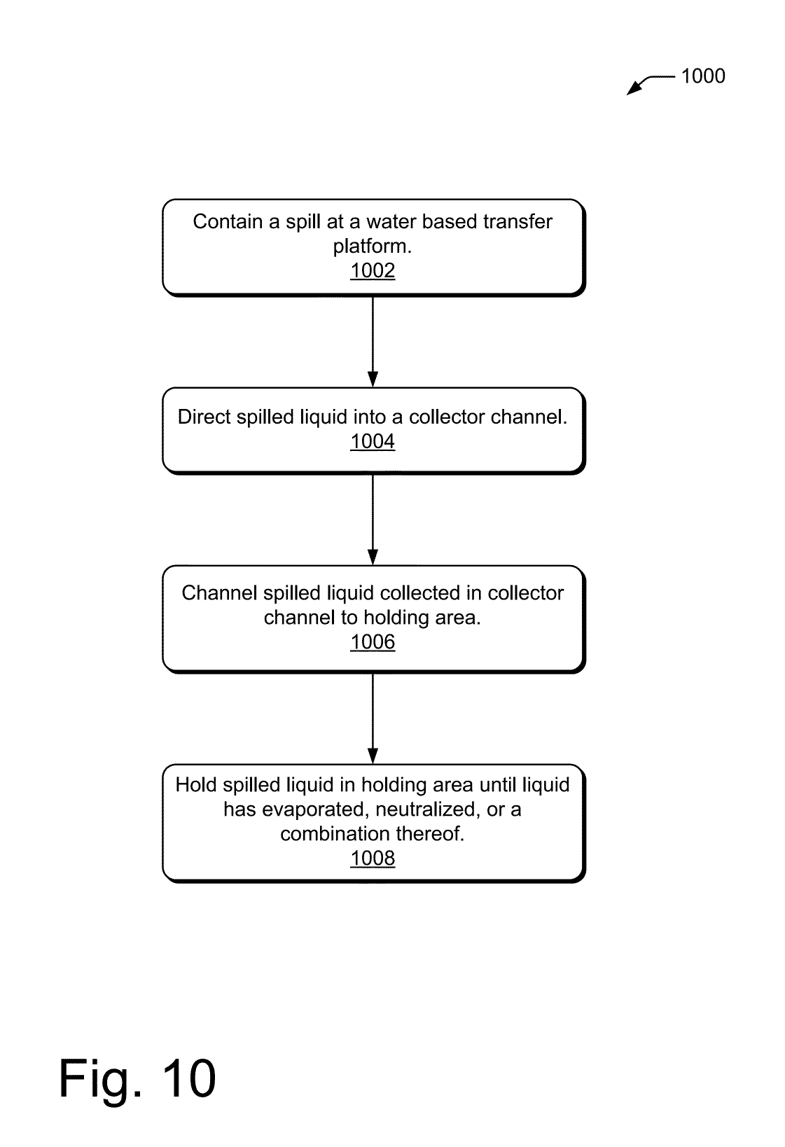

FIG. 10 shows a method 1000 where, at 1002 a spill is contained at the water based transfer platform.

At 1004, the spilled liquid is directed to a collector channel. For example, a slope of the surface of the platform may provide a direction for a liquid to collect in the collector channel.

At 1006, the spilled liquid is channeled by the collector channel to a holding area. For example, the collector channel may comprise a slope along a portion of the length of the collector channel that may provide a gravity driven method of moving collected spilled liquid to the holding area.

At 1008, the spilled liquid is held in the holding area. Various embodiments contemplate that the spilled liquid is held until the liquid has been neutralized. For example, the liquid may evaporate or disperse, the liquid may be treated to neutralize or reduce some or all undesired characteristics, the liquid may be captured, contained, and/or removed, or combinations thereof.

### Illustrative Systems

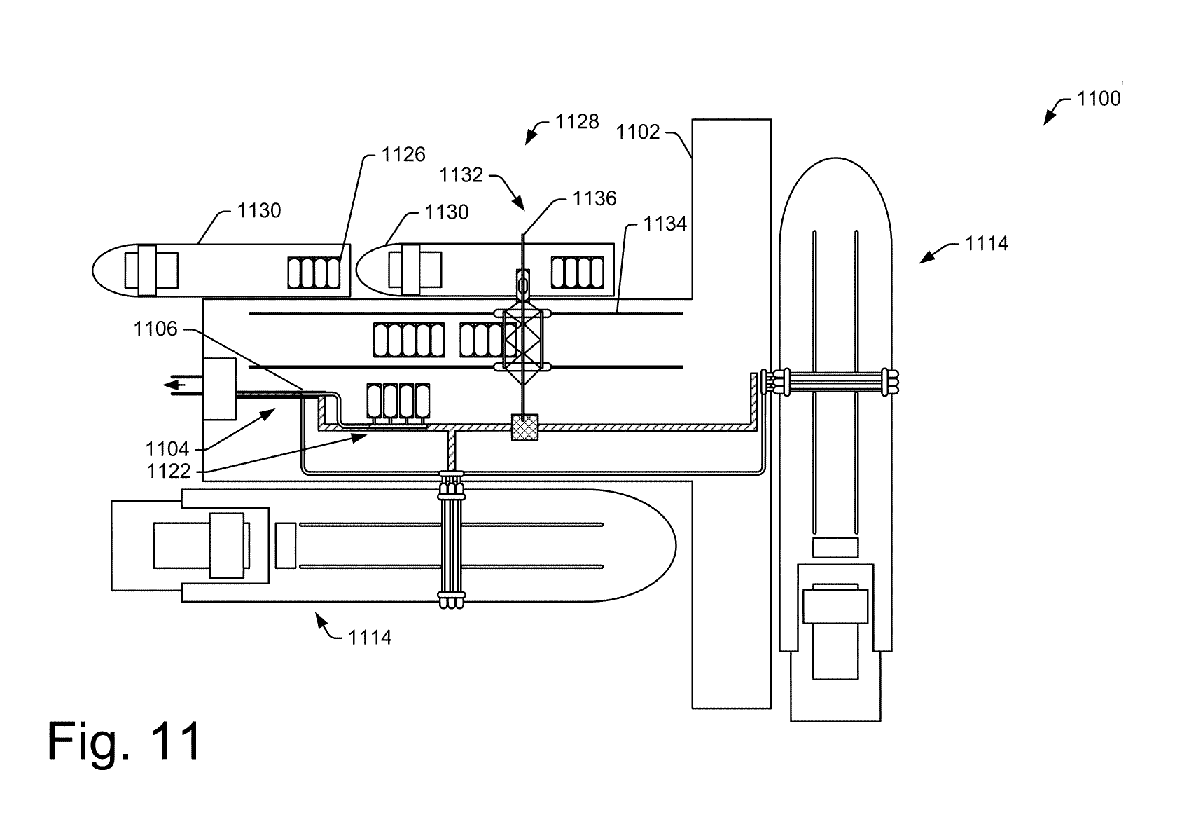

FIG. 11 shows an illustrative water based transfer system 1100. Various embodiments contemplate that the water based transfer system 1100 may comprise a platform 1102 with a spill containment system 1104. The spill containment system 1104 may be configured to collect and in some embodiments hold and or neutralize a liquid spilled from a liquid transfer system 1106. Various embodiments contemplate that liquid may be transferred through the liquid transfer system 1106 from a source, for example a vessel 1114.

Additionally or alternatively, various embodiments contemplate that water based transfer system 1100 may further comprise a distribution system 1122. Various embodiments contemplate that distribution system 1122 may transfer liquid from the liquid transfer system 1106 to one or more storage systems 1126.

FIG. 11 also shows a storage system 1126 management system 1128. Various embodiments contemplate that management system 1128 may facilitate the filling of one or more storage systems 1126 through liquid transfer system 1106, for example, from vessel 1114. Various embodiments contemplate management system 1128 may facilitate the storage of empty and filled storage systems 1126. Additionally or alternatively, various embodiments contemplate management system 1128 facilitating the loading and unloading of full and/or empty storage systems 1126 from a transport vessel 1130. Various embodiments contemplate that transport vessel 1130 may be configured to deliver storage systems 1126 to locations desiring the liquid. For example, when the liquid is LNG, various embodiments contemplate delivering LNG in ISO containers to locations desiring natural gas where it may be impractical to supply natural gas through a pipeline and/or or a natural gas pipeline is unavailable.

Additionally or alternatively, various embodiments contemplate that management system 1128 may comprise a storage system 1126 movement system 1132, for example, a crane, one or more carts, trucks, slides, combinations thereof, among others. Various embodiments contemplate that movement system 1132 may be configured to move in a direction substantially parallel to an axis of the transport vessel 1130, for example, along tracks 1134. Additionally or alternatively, various embodiments contemplate that movement system 1132 may be configured to move in a direction substantially perpendicular to an axis of the transport vessel 1130, for example, along gantry 1136.

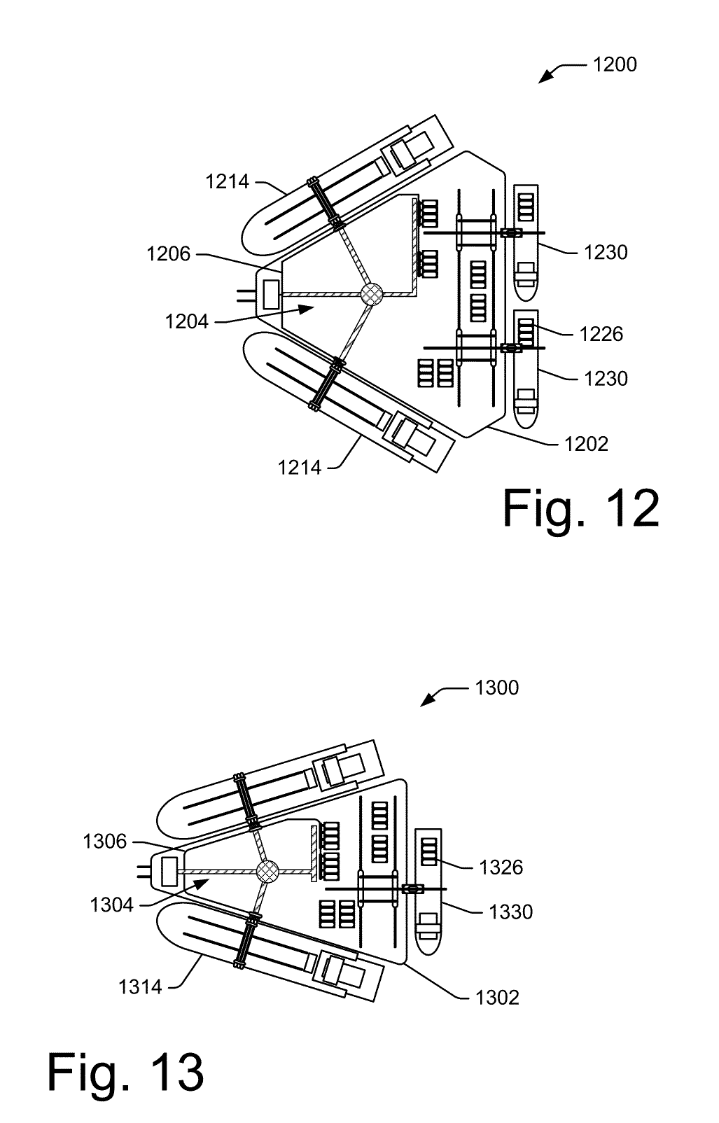

FIG. 12 shows an illustrative water based transfer system 1200. Various embodiments contemplate that the water based transfer system 1200 may comprise a platform 1202 with a spill containment system 1204. The spill containment system 1204 may be configured to collect and in some embodiments hold and or neutralize a liquid spilled from a liquid transfer system 1206. Various embodiments contemplate that liquid may be transferred through the liquid transfer system 1206 from a source, for example a vessel 1214. Additionally or alternatively, transport vessels 1230 may receive and deliver storage systems 1226.

FIG. 13 shows an illustrative water based transfer system 1300. Various embodiments contemplate that the water based transfer system 1300 may comprise a platform 1302 with a spill containment system 1304. The spill containment system 1304 may be configured to collect and in some embodiments hold and or neutralize a liquid spilled from a liquid transfer system 1306. Various embodiments contemplate that liquid may be transferred through the liquid transfer system 1306 from a source, for example a vessel 1314. Additionally or alternatively, transport vessels 1330 may receive and deliver storage systems 1326.

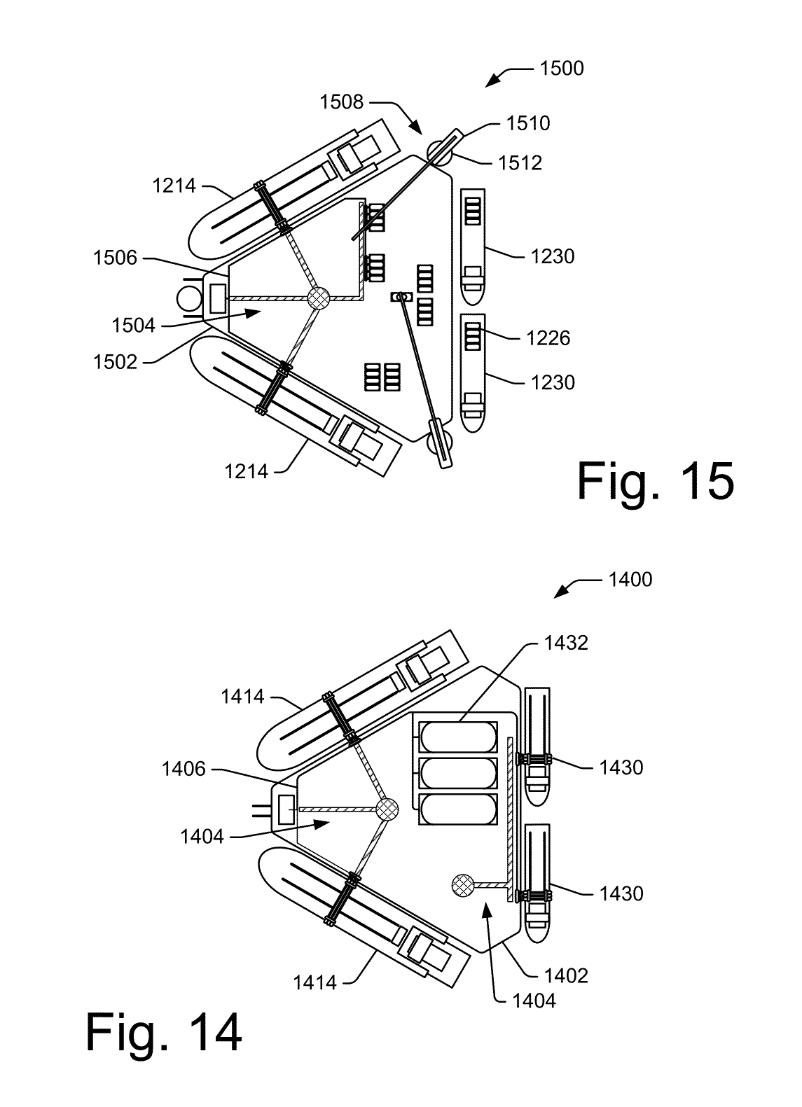

FIG. 14 shows an illustrative water based transfer system 1400. Various embodiments contemplate that the water based transfer system 1400 may comprise a platform 1402 with one or more spill containment systems 1404. The spill containment systems 1404 may be configured to collect and in some embodiments hold and or neutralize a liquid spilled from a liquid transfer system 1406. Various embodiments contemplate that liquid may be transferred through the liquid transfer system 1406 from a source, for example a vessel 1414. Additionally or alternatively, transport vessels 1430 may receive liquid transferred from a vessel 1414. Additionally or alternatively, transport vessels 1430 may receive liquid transferred from one or more liquid storage vessels 1432. Additionally or alternatively, transport vessels 1430 may receive liquid transferred from a combination of one or more liquid storage vessels 1432 and a vessel 1414.

Various embodiments contemplate that transport vessels 1430 provide a bunkering type service. For example, if the liquid is LNG, transport vessel 1430 may fill from one or both of the vessel 1414 or liquid storage vessels 1432.

Additionally or alternatively, various embodiments contemplate that a flow rate of the liquid from the vessel 1414 to the liquid transfer system 1406 may be a first flow rate. Various embodiments contemplate that one or more liquid storage vessels 1430 may be filled by the flow from the vessel 1414 at the first flow rate. Additionally or alternatively, various embodiments contemplate that the transport vessel 1430 may be filled from one or more of the liquid storage vessels 1430 at a second flow rate. Various embodiments contemplate that the second flow rate may be higher, equal to, or lower than the first flow rate.

For example, if the liquid is LNG and transport vessels 1430 are providing a bunkering type service, it is possible that the transport vessel 1430 desires to be filled in a rapid manner. As such, the second flow rate may be larger than the first flow rate. This may allow a transport vessel 1430 to connect to the liquid transfer system 1406, be filled by the liquid in a relatively rapid manner, and depart the platform 1402 in order to provide a timely bunkering service to another ship (not pictured).

Additionally or alternatively, various embodiments contemplate that water based transfer system 1400 may comprise one or more liquid storage vessels 1432 located on the platform 1402, in the platform 1402, or combinations thereof.

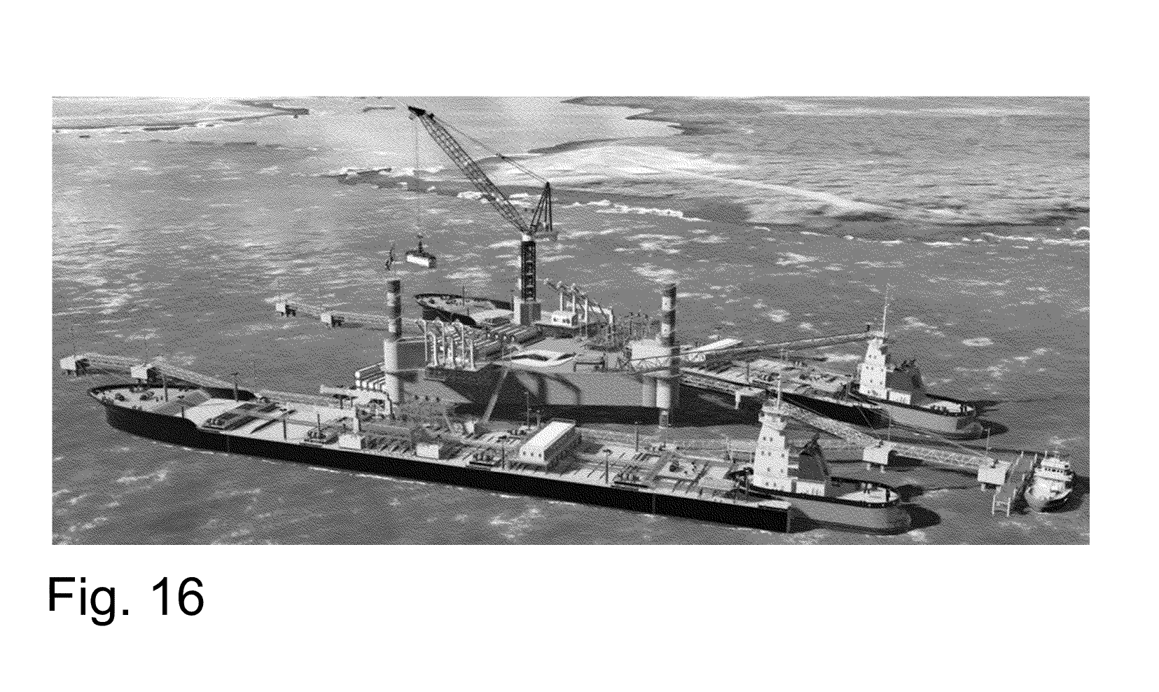

FIG. 15 shows an illustrative water based transfer system 1500. Various embodiments contemplate that the water based transfer system 1500 may comprise a platform 1502 with a spill containment system 1504. The spill containment system 1504 may be configured to collect and in some embodiments hold and or neutralize a liquid spilled from a liquid transfer system 1506. Various embodiments contemplate that liquid may be transferred through the liquid transfer system 1506 from a source, for example a vessel 1214. Additionally or alternatively, transport vessels 1230 may receive and deliver storage systems 1226. Various embodiments contemplate that the water based transfer system 1500 may comprise a management system 1508, may comprise a storage system 1226, movement system 1510, for example, a crane, one or more carts, trucks, slides, combinations thereof, among others. Various embodiments contemplate that the movement system 1510 may comprise a pedestal jib crane. Various embodiments contemplate that the pedestal jib crane may be located on one or more support structures 1512. Various embodiments contemplate that support structure 1512 may comprise a leg of a jack-up platform.

FIG. 16 shows an illustrative perspective view of a three dimensional rendering of a water based transfer system.

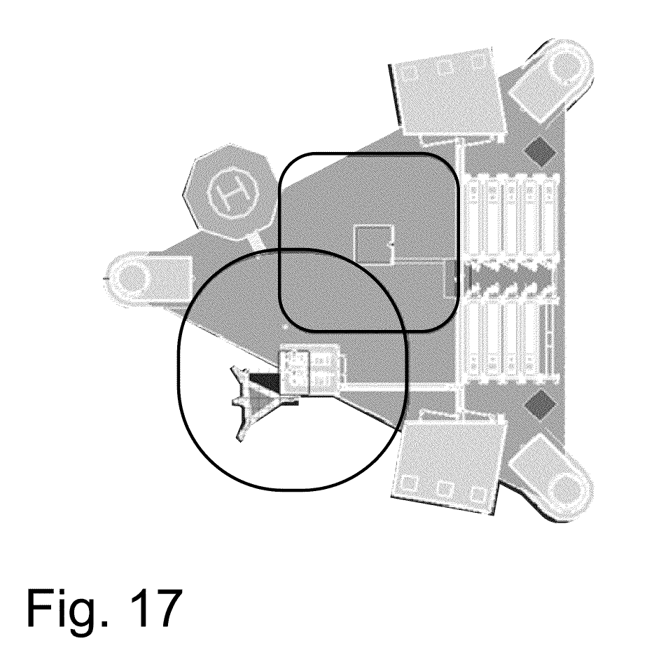

FIG. 17 shows an illustrative top down view of an illustrative water based transfer system.

### CONCLUSION

Various aspects of the subject matter described above can be implemented in various systems and configurations. Although implementations have been described in language specific to structural features and/or methodological acts, it is to be understood that the subject matter defined in the appended claims is not necessarily limited to the specific features or acts described above. Rather, the specific features and acts are disclosed as example forms of implementing the claims. For example, the methodological acts need not be performed in the order or combinations described herein, and may be performed in any combination of one or more acts.

What is claimed is:

1. A system comprising:
a water based transfer platform;
a supply vessel holding or receiving a liquid fuel detachably coupled to the water based transfer platform; and
a spill containment system located on the water based transfer platform, the spill containment system comprising:
one or more trenches disposed in a surface of the water based transfer platform, the one or more trenches configured to collect a liquid and direct it in one or more directions; and
one or more sumps coupled to the one or more trenches, the one or more sumps configured to receive liquid collected from the one or more trenches and also configured to hold the liquid.

2. The system of claim 1, wherein the liquid is held in the one or more sumps until the liquid is neutralized.

3. The system of claim 1, wherein the liquid is held in the one or more sumps until the liquid has evaporated.

4. The system of claim 1, wherein the supply vessel comprises one or more of a ship, a barge, or a combination thereof.

5. The system of claim 1, wherein:
the supply vessel is configured to transfer the liquid fuel to the water based transfer platform at a transfer flow rate;
the transfer flow rate is below a threshold level; and
the spill containment system is configured to collect and hold a spill at the transfer flow rate for a spill period of time.

6. The system of claim 5, wherein the spill period of time is less than 20 minutes.

7. The system of claim 5, wherein the threshold level is less than 500 cubic meters per hour.

8. The system of claim 5, wherein the threshold level is less than 3,000 cubic meters per hour.

9. The system of claim 5, wherein the transfer flow rate is within a flow margin of a distribution rate.

10. The system of claim 1, wherein the one or more trenches are sloped towards the one or more sumps.

11. The system of claim 1, wherein the one or more trenches comprise an aerated concrete.

12. The system of claim 1, wherein the one or more sumps are located away from structures and systems on the water based transfer platform.

13. The system of claim 1, wherein the liquid fuel is liquid natural gas.

14. A water based transfer platform detachably coupleable to a supply vessel holding or receiving a liquid fuel, the water based transfer platform comprising:
a liquid fuel transfer system; and
a spill containment system disposed in a surface of the water based transfer platform, the spill containment system comprising:
one or more holding cavities; and
one or more collectors having a first end, second end, and an edge,
the one or more holding cavities coupled to the first end,
one or more of the second end, the edge, or a combination thereof is located near a portion of the liquid fuel transfer system,
the one or more collectors configured to collect a spill from the portion of the liquid fuel transfer system and direct it to one or more of the one or more holding cavities.

15. The water based transfer platform of claim 14, wherein the liquid fuel transfer system comprises one or more transfer interfaces; the one or more of the second end, the edge, or a combination thereof is located near the one or more transfer interfaces.

16. The water based transfer platform of claim 14, further comprising a leak vapor disbursement system, the disbursement system comprising: one or more of a fan, wind diverter, or combinations thereof.

17. The water based transfer platform of claim 14, wherein the spill is held in the one or more holding cavities until the spill has evaporated.

18. The water based transfer platform of claim 14, wherein the supply vessel comprises one or more of a ship, a barge, or a combination thereof.

19. The water based transfer platform of claim 14, wherein:
the supply vessel is configured to transfer the liquid fuel to the water based transfer platform at a transfer flow rate;
the water based transfer platform is configured to distribute the liquid fuel at a distribution rate, wherein the transfer flow rate and the distribution rate are within a rate limit of each other; and
the spill containment system is configured to collect and hold a spill at the transfer flow rate for a spill period of time.

20. The water based transfer platform of claim 14, wherein the liquid fuel is liquid natural gas.

21. A method comprising:
transporting a supply vessel storing fuel to a water based transfer platform;
connecting the supply vessel to the water based transfer platform, the water based transfer platform having a spill containment system;
transferring fuel from the supply vessel to the water based transfer platform at a first flow rate, the first flow rate below a flow rate threshold; and
distributing the fuel to consumers at a second flow rate, the second flow rate within a second flow rate threshold of the first flow rate.

22. The method of claim 21, further comprising containing a spill of the fuel.

23. The method of claim 22, wherein the containing the spill comprises:
directing spilled fuel into a collector channel;
channeling the spilled fuel collected in the collector channel to a holding area; and
holding the collected spilled fuel in the holding area until the spilled fuel is neutralized, has evaporated, or a combination thereof.

24. The method of claim 22, wherein the fuel and the spill comprise liquid natural gas.

25. The method of claim 23, wherein the directing comprises locating sloped areas around the spill, a sloped surface of the sloped area is orientated to direct a least a portion of a spilled fuel towards the collector channel.
